(19) United States
(12) Patent Application Publication
(10) Pub. No.: US 2007/0196715 A1
(43) Pub. Date: Aug. 23, 2007

(54) Fuel cell device adapted to slim-type CD-ROM drive

(76) Inventors: Hsi-Ming Shu, Taipei (TW); Feng-Yi Deng, Taipei (TW); Yean-Der Kuan, Taipei (TW)

Correspondence Address: G. LINK CO., LTD, 3550 Bell Road, MINOOKA, IL, 60447, US

(21) Appl. No.: 11/356,990

(22) Filed: Feb. 21, 2006

(51) Int. Cl. H01M 8/02; H01M 8/04

(52) U.S. Cl. 429/34; 429/23

(57) ABSTRACT

A fuel cell device adapted to a slim-type CD-ROM drive is disclosed. A fuel cell module comprises at least a fuel cell board fabricated by a printed circuit board process. A circuit unit comprises a circuit board and at least a circuit component. The circuit components are disposed on the circuit board and are electrically connected to the fuel cell module. A connecting interface used as a output end for outputting power of the fuel cell module and connecting with an electrical device. The fuel cell module, the circuit unit and the connecting interface constitute an exterior adapted to the exterior of the slim-type CD-ROM drive.

### FIELD OF THE INVENTION

The present invention relates to a fuel cell device, and more particularly, to a fuel cell device that is adaptable to a slim-type of CD-ROM drive.

### BACKGROUND OF THE INVENTION

Nowadays, there are two ways to connect a fuel cell device with an electrical device. One way is to utilize the compartment of the electrical device, that is, dedicated space is reserved for the fuel cell device, to integrate the fuel cell device with a portable electrical machine. However, conventional fuel cell device is limited to specifically dedicated electrical devices, and the electrical device is restricted to compatible with special fuel cell devices only. And, the other way is to connect the electrical device and fuel cell device with a power cord. This connecting way is simple but inconvenient to use portable electrical devices, such as notebooks, since they are not integrated with the fuel cell devices.

Accordingly, the fuel cell device and the portable electrical device cannot be integrated with each other until the exterior of a conventional fuel cell device is under uniform specification.

Thus, a fuel cell device adapted to a slim-type CD-ROM drive is provided to overcome the aforesaid disadvantages, and thereby the portable electrical device is integrated with the fuel cell device.

### SUMMARY OF THE INVENTION

It is a primary object of the invention to provide a fuel cell device that is integrated with a portable electrical device easily.

In accordance with the objects of the invention, a fuel cell device adapted to a slim-type CD-ROM drive is provided. The fuel cell device comprises a fuel cell module including at least a fuel cell board fabricated by a printed circuit board process, and a circuit unit including a circuit board and at least a circuit component. The circuit components are disposed on the circuit board and are electrically connected to the fuel cell module. The fuel cell device also comprises a connecting interface for outputting power of the fuel cell module and connecting with an electrical device. The fuel cell module, the circuit unit and the connecting interface constitute an exterior accommodated to the exterior of a slim-type CD-ROM drive.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a schematic view of a fuel cell device adapted to a slim-type CD-ROM drive according to one embodiment of the invention;

FIG. 2 is the top view of a fuel cell device adapted to a slim-type CD-ROM drive according to the invention;

FIG. 3 is a schematic elevation showing a fuel cell device is inserted into a notebook according to the invention;

FIG. 4 is a schematic elevation of a fuel cell module according to the invention;

FIG. 5 is a schematic view showing a fuel cell device adapted to a slim type CD-ROM drive according to another preferred embodiment of the invention;

FIG. 6 is the top view of a fuel cell device adapted to a slim-type CD-ROM drive according to another preferred embodiment of the invention; and

FIG. 7 is a schematic view showing a fuel cell device is inserted into a notebook in accordance with another preferred embodiment of the invention.

### DETAILED DESCRIPTION OF THE INVENTION

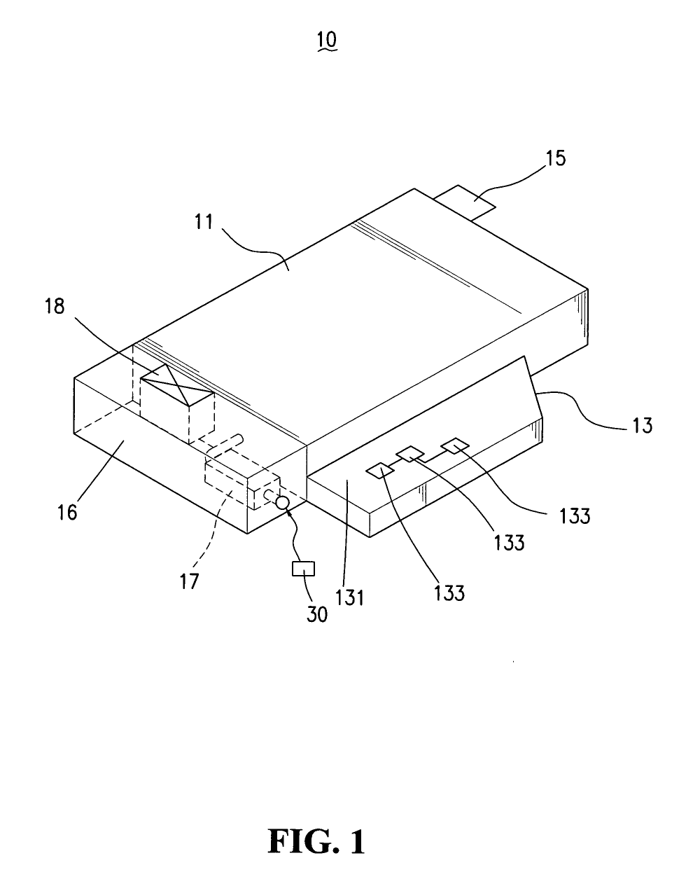

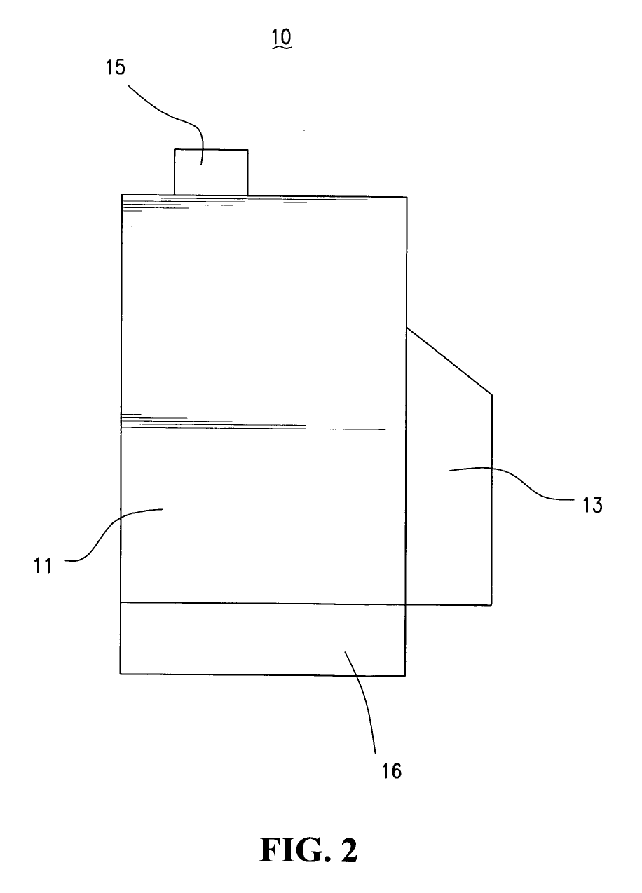

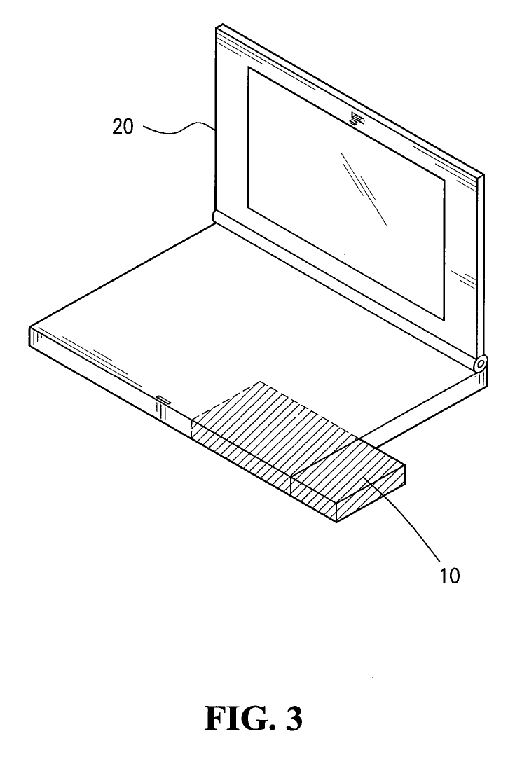

FIG. 1 is a schematic view showing a fuel cell device adapted to a slim-type CD-ROM drive according to one embodiment of the invention. FIG. 2 is the top view of a fuel cell device adapted to a slim-type CD-ROM drive according to one embodiment of the invention. FIG. 3 is a schematic elevation showing a fuel cell device is inserted into a notebook. The exterior of a fuel cell device 10 is completely conformed to the slim-type CD-ROM drive. Accordingly, the space occupied by the slim-type CD-ROM drive in an electrical device 20, such as a notebook, can be utilized. The fuel cell device 10 will not be installed until the slim-type CD-ROM drive released from the electrical device 20, and then the electrical device 20 can immediately use the power of the fuel cell device 10. The fuel cell device 10 includes a fuel cell module 11, a circuit unit 13 and a connecting interface 15. It is noted that the fuel cell module 11, the circuit unit 13 and the connecting interface 15 constitute an exterior, which is adapted to the exterior of the slim-type CD-ROM drive.

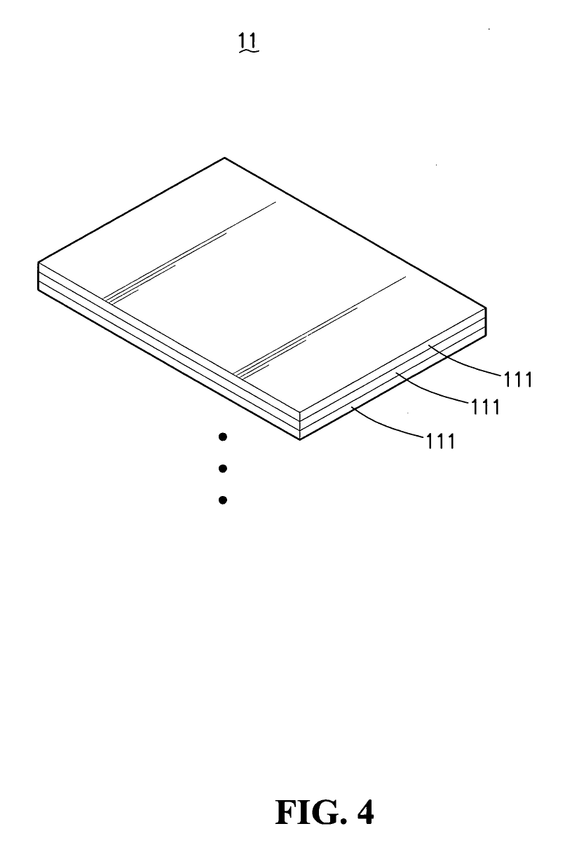

FIG. 4 is a schematic elevation of a fuel cell module according to one embodiment of the invention. The fuel cell module 11 is formed by sealed stacking at least a fuel cell board 111. The fuel cell board 111 may be a bipolar fuel cell board fabricated by printed circuit board (PCB) processes. Besides, the fuel cell module 11 includes a flow-field structure (not shown). The fuel cell module 11 having the flow-field structure and the bipolar fuel cell boards is disposed corresponding to a CD holder of the slim-type CD-ROM drive. The flow-field structure serves to supply fuel for each fuel cell board 111 and to drain out products generated by the fuel cell boards 111 during the electrochemical reaction.

Referring to FIG. 1, the circuit unit 13 includes a circuit board 131 and at least a circuit component 133 soldered on the circuit board 131. The circuit components 133 can be designed to be, for example, an electric management circuit or a voltage circuit for different requirements. The circuitry of the circuit component 133 is electrically connected to the fuel cell module 11 and the connecting interface 15. Thereby, power of the fuel cell module 11 is processed by the circuit unit 13, and then provided for the electrical device 20 through the connecting interface 15.

The connecting interface 15 is used to output power of the fuel cell module 11, and to connect the fuel cell device 10 with the electrical device 20. The connecting interface 15 may be a PCB having golden fingers, a connector or a cable, and is disposed on the side corresponding to the IDE interface of the slim-type CD-ROM drive.

The fuel cell device 10 further includes a housing 16, a pump 17 and a fan 18. The pump 17 and the fan 18 are deployed within the housing 16. The housing 16 is disposed adjacent to the side of the fuel cell module 11 corresponding to the panel of the slim-type CD-ROM drive. External fuel 30 (e.g. methanol solution) are transported into the flow-field structure of the fuel cell module 11 by the pump 17. Heat generated during electrochemical reaction in the fuel cell module 11 is radiated by the fan 18. The fan 18 aids in air flowing into the fuel cell module 11 as well.

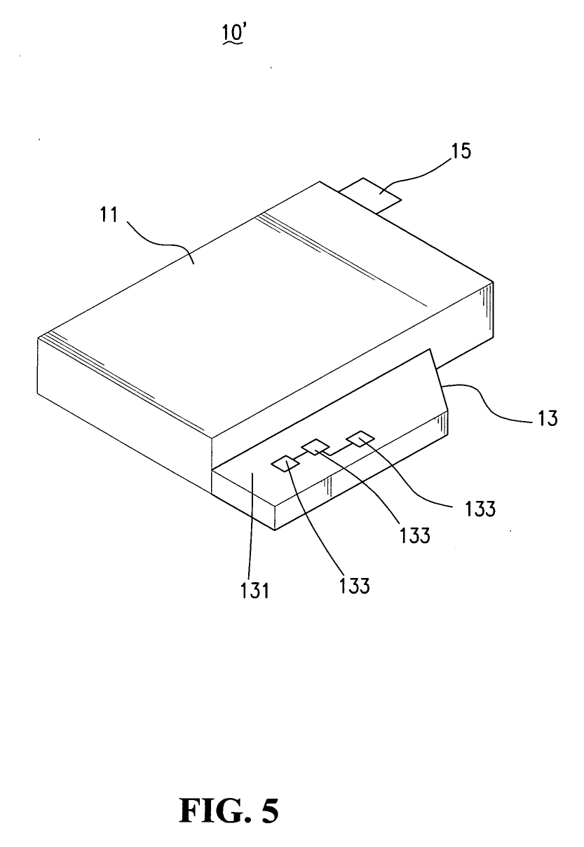

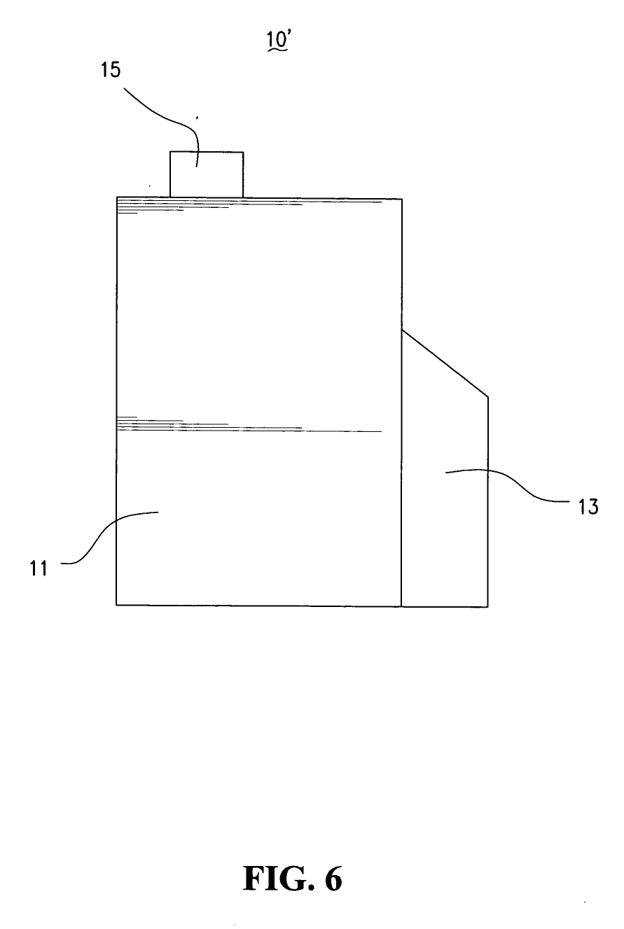

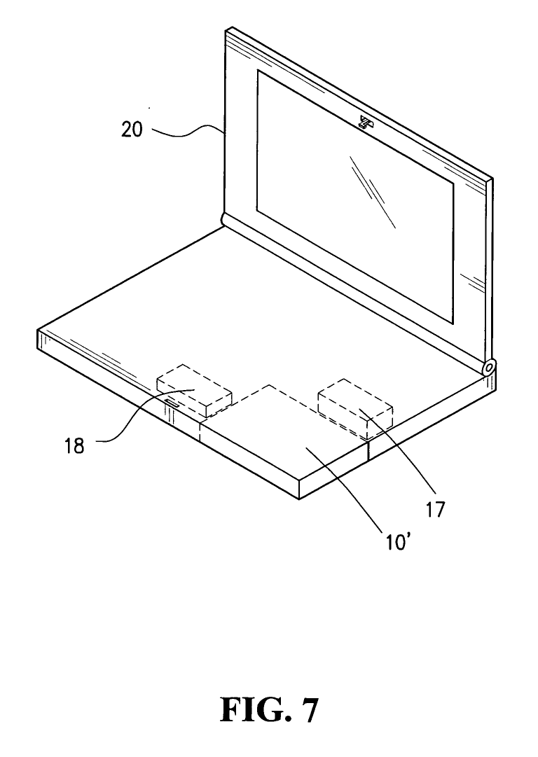

With reference to FIGS. 5-7 to describe a fuel cell device adapted to a slim type CD-ROM drive according to another preferred embodiment of the invention, FIG. 5 is a schematic view showing a fuel cell device adapted to a slim type CD-ROM drive, FIG. 6 is the top view of a fuel cell device adapted to a slim-type CD-ROM drive; and FIG. 7 is a schematic view showing a fuel cell device is inserted into a notebook. In this preferred embodiment, the fuel cell device 10′ has the pump 17 and the fan 18 built inside of the electrical device 20.

It is noted that the fuel cell device 10 can be applied to any kind of electrical device 20 with a slim-type CD-ROM drive. Hence, the electrical device 20 is used for a long time as the slim-type CD-ROM drive is withdrawn and then the fuel cell device 10 is installed.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A fuel cell device adapted to a slim-type CD-ROM drive, the device comprising:
a fuel cell module including at least a fuel cell board fabricated by a printed circuit board process;
a circuit unit including a circuit board and at least a circuit component, wherein the circuit components are disposed on the circuit board and electrically connected to the fuel cell module; and
a connecting interface for outputting power of the fuel cell module and connecting with an electrical device;
wherein the fuel cell module, the circuit unit and the connecting interface constitute an exterior adapted to an exterior of a slim-type CD-ROM drive.

2. The device of claim 1, wherein the fuel cell board is a bipolar fuel cell board.

3. The device of claim 1, wherein the connecting interface is a printed circuit board with a golden finger.

4. The device of claim 1, wherein the connecting interface is a connector.

5. The device of claim 1, wherein the connecting interface is a cable.

6. The device of claim 1, further comprising a fan disposed on a side of the fuel cell module corresponding to a panel of the slim-type CD-ROM drive.

7. The device of claim 1, further comprising a pump disposed on a side of the fuel cell module corresponding to a panel of the slim-type CD-ROM drive.

8. The device of claim 6, further comprising a housing disposed on a side of the fuel cell module corresponding to a panel of the slim-type CD-ROM drive, wherein the fan is disposed within the housing.

9. The device of claim 6, wherein the fan is disposed within the electrical device.

10. The device of claim 7, further comprising a housing disposed on a side of the fuel cell module corresponding to a panel of the slim-type CD-ROM drive, wherein the pump is disposed within the housing.

11. The device of claim 7, wherein the pump is disposed within the electrical device.

12. The device of claim 1, wherein the circuit component is an electric management circuit.

13. The device of claim 1, wherein the circuit component is a voltage circuit for providing a required voltage for the electrical device, and the voltage circuit is connected to the connecting interface.

14. The device of claim 1, wherein the electrical device is a notebook or a portable electrical device.
